(19) United States
(12) Patent Application Publication
(10) Pub. No.: US 2023/0159753 A1
(43) Pub. Date: May 25, 2023

(54) POLYROTAXANE ADDITIVES FOR RIGID POLYMERS

(71) Applicants: The Texas A&M University System, College Station, TX (US); KANEKA CORPORATION, Osaka (JP)

(72) Inventors: Hung-Jue Sue, College Station, TX (US); Masaya Kotaki, Pasadena, TX (US); Zewen Zhu, College Station, TX (US)

(73) Assignees: The Texas A&M University System, College Station, TX (US); KANEKA CORPORATION, Osaka (JP)

(21) Appl. No.: 17/975,220

(22) Filed: Oct. 27, 2022

Related U.S. Application Data
(60) Provisional application No. 63/272,327, filed on Oct. 27, 2021.

(51) Int. Cl. C08L 79/04

(52) U.S. Cl. CPC C08L 79/04

(57) ABSTRACT

A resin composition is provided. The resin composition includes a rigid polymer resin, a functionalized polyrotaxane, and (optionally) a core-shell polymer. The resin composition may be cured to form a cured thermoset resin. The cured thermoset set has improved mechanical properties relative to a reference cured thermoset. A method of preparing a cured article of the curable resin composition is also provided. The method includes providing the curable resin composition and curing the curable composition.

### BACKGROUND

Rigid polymers have high rigidity and strength and are often used to make lightweight structural components. Rigid polymers typically have exceptional thermal and oxidative stability; however, they tend to be quite brittle. For use in high temperature applications, a rigid polymer may need a high glass transition temperature (Tg), above which the properties of the polymer tend to abruptly change.

Benzoxazines are one example of monomers that cure to a crosslinked thermoset on heating. Benzoxazine resins exhibit high thermal stability, high chemical resistance, low water absorption, near-zero shrinkage and expansion upon thermal curing, and outstanding mechanical properties as compared to thermosets formed from epoxy, phenolic, or bismaleimide monomers. Aromatic cyanates are another class of monomers that can be cured to form rigid polymers. The resultant thermosets have high performance, including high glass transition temperatures, low water absorption, and excellent dielectric properties. As is common of thermosets with high glass transition temperatures (>150° C.), they are brittle.

In contrast, benzoxazine resins possess significant hydrogen bonding, which can improve the solvent resistance and the adhesion to the fibers that are often used to reinforce the polymer. Besides rich molecular design flexibility, the benzoxazine monomer itself is preferable for processing due to its low melt-viscosity, effective polymerization without the need for harsh catalysts, and lack of byproducts formed during polymerization. With the above characteristics, benzoxazine resins are promising as matrices for high performance thermoset composites in the fields of aerospace, electronics, adhesives, coatings, etc.

Benzoxazines are used to make glass and carbon fiber composites used for electrical circuit boards, aerospace applications, and other uses. Although benzoxazines have exceptional thermal and oxidative stability, generally better than epoxy resins, they are also very brittle. For example, when drilling circuit boards made from benzoxazine and glass fiber, cracking can occur along the fiber-resin interface. This cracking can eventually lead to circuit failure due to ions wicking into the crack during etching and plating operations. The use of benzoxazines for aerospace composites is limited in manned aircraft because of similar cracks during machining and maintenance operations. These cracks, which may be invisible and difficult to test for, can initiate catastrophic failure during flight.

Blending or alloying of benzoxazine resins with various other resins or polymers, such as epoxy resins, urethane resins, and anhydrides, have been reported to provide a class of curable compositions with enhanced performance, improving the high rigidity of benzoxazines. However, the cured compositions or resulting alloys possess low tensile properties and/or low glass transition temperatures.

Benzoxazines have been formulated with tougheners to improve toughness and ductility. Toughness can be improved by physical blending or chemical modification. However, tougheners typically cause a reduction of the glass transition temperature (Tg) and modulus.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a resin composition comprising a rigid polymer, a functionalized polyrotaxane, and (optionally) a core-shell polymer.

In another aspect, embodiments disclosed herein relate to a cured thermoset of a resin composition. The resin composition of the cured thermoset includes a rigid polymer, a functionalized polyrotaxane, and (optionally) a core-shell polymer.

In yet another aspect, embodiments disclosed herein relate to a method of forming a cured article of a curable composition. The method includes providing a curable resin composition and curing the curable composition to form the cured article. The resin composition of the disclosed method includes a rigid polymer, a functionalized polyrotaxane, and (optionally) a core-shell polymer.

Other aspects and advantages of the claimed subject matter will be apparent from the following description and the appended claims.

### BRIEF DESCRIPTION OF DRAWINGS

FIG. 1 is a schematic representation of the synthesis of an epoxide-modified polyrotaxane of one or more embodiments.

FIG. 2 is a proton NMR spectrum of epoxide functionalized polyrotaxane of one or more embodiments.

FIGS. 3A-3C are schematics of a molecular mechanism for improved ductility and toughening achieved when functionalized polyrotaxane is added to a benzoxazine resin of one or more embodiments.

FIGS. 4A-4C are TEM images showing benzoxazine resin alone (FIG. 4A), benzoxazine resin blended with polyrotaxane (FIG. 4B), and benzoxazine resin blended with epoxidized polyrotaxane (FIG. 4C), in accordance with one or more embodiments.

### DETAILED DESCRIPTION

The present disclosure generally relates to a resin composition that includes rigid polymers and tougheners. Tougheners are additives added to rigid polymers to improve their toughness and ductility; however, tougheners tend to also decrease the modulus and glass transition temperature of the rigid polymers. The resin compositions disclosed herein may provide an improvement in the toughness of the cured resin without sacrificing the modulus or glass transition temperature of the cured resin.

Compositions disclosed herein include a combination of resin components that provides improved toughness without detrimental decreases in modulus or glass transition temperature of a cured thermoset product. In particular, embodiments of the present disclosure relate to a resin composition comprising a rigid polymer resin, a functionalized polyrotaxane and (optionally) a core-shell polymer particle. Rigid polymers that include a functionalized polyrotaxane and (optionally) a core-shell polymer particle may have improved toughness as compared to a rigid polymer without the aforementioned components. Additionally, rigid polymers that include a functionalized polyrotaxane and (optionally) a core-shell polymer particle may provide a greater modulus when compared to rigid polymers that include conventional tougheners, such as core shell polymers alone.

As used herein “rigid polymer” refers to a polymer having a tensile modulus above 1.5 GPa (gigapascal). Examples of rigid polymers in accordance with the present disclosure include (but are not limited to) polypropylene, polyvinyl chloride, polyethylene terephthalate, polylactide, polycarbonate, poly(methyl methacrylate), polyphenylene sulfide, epoxy thermosets, cyanate ester thermosets, polyimide, and polybenzoxazine. In one or more embodiments, the rigid polymer may include a thermoplastic resin such as high-density polypropylene, polyvinyl chloride, polyethylene terephthalate, polycarbonate, poly(methyl methacrylate), and polyphenylene sulfide. In one or more embodiments, the compositions disclosed herein are particularly useful for extremely brittle thermosetting resins such as benzoxazine resins.

One or more embodiments of the present disclosure relate to a thermoset made from a thermosetting benzoxazine-based resin. The thermosetting benzoxazine-based resin includes at least one benzoxazine (BZ) group therein (along the backbone or in an end-cap), or it is formed from a BZ monomer (ring-opening during the formation of the benzoxazine-based resin) or a combination thereof. The BZ group in the benzoxazine-based resin or BZ monomer may have a structure represented by formula (I):

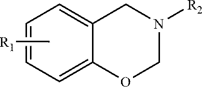

R1 may represent one or more of a hydrogen atom, a hydrocarbon group, a substituted hydrocarbon group, and a functional group. The BZ groups of one or more embodiments may include one or more substituents represented by R1. As used throughout this description, the term “hydrocarbon group” may refer to branched, straight-chain, and/or ring-containing hydrocarbon groups, which may be saturated or unsaturated. The hydrocarbon groups may be primary, secondary, and/or tertiary hydrocarbons. As used throughout this description, the term “substituted hydrocarbon group” may refer to a hydrocarbon group (as defined above) where at least one hydrogen atom is replaced with a non-hydrogen group that results in a stable compound. Such substituents may be groups selected from (but are not limited to) halo, hydroxyl, alkoxy, oxo, alkanoyl, aryloxy, alkanoyloxy, amino, alkylamino, arylamino, arylalkylamino, disubstituted amines, alkanylamino, aroylamino, aralkanoylamino, substituted alkanoylamino, substituted arylamino, aubstituted aralkanoylamino, thiol, alkylthio, arylthio, arylalkylthio, alkylthiono, arylthiono, aryalkylthiono, alkylsulfonyl, arylsulfonyl, arylalkylsulfonyl, sulfonamide, substituted sulfonamide, nitro, cyano, carboxy, carbamyl, alkoxycarbonyl, aryl, substituted aryl, guanidine, vinyl, acetylene, acrylate, cyanate, epoxide, and heterocyclic groups, and mixtures thereof. The functional groups may be groups selected from (but are not limited to) halo, hydroxyl, alkoxy, oxo, amino, amido, thiol, alkylthio, sulfonyl, alkylsulfonyl, sulfonamide, substituted sulfonamide, nitro, cyano, carboxy, carbamyl, alkoxycarbonyl vinyl, acetylene, acrylate, cyanate, epoxide groups, and mixtures thereof.

R2 is not particularly limited and may represent any of the groups mentioned with regard to R1. However, in particular embodiments, R2 may be a BZ-containing moiety. When R2 is a BZ-containing moiety, the BZ-based resin may include bis-BZ units. The bis-BZ units may have a structure represented by formula (II):

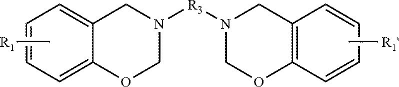

R1 represents a group as discussed above with regard to formula (I). R1′ may be a group that is the same as, or different from, R1. R3 may represent a hydrocarbon group or a substituted hydrocarbon group. In particular embodiments, R3 may represent an aromatic group selected from (but not limited to) benzene, bibenzyl, diphenylmethane, naphthalene, anthracene, diphenyl ether, diphenyl sulfone ether, bis(phenoxy) benzene, stilbene, phenanthrene, fluorine, and substituted variants thereof. In one or more embodiments, R3 may represent a group having a molecular weight in a range of about 14 to 100,000 Da, or 14 to 10,000 Da, or 14 to 1,000 Da.

In one or more embodiments, the resin composition may include a polyrotaxane as a toughener, and in particular embodiments, the polyrotaxane may be functionalized. In one or more embodiments in which the polyrotaxane is functionalized, the functionalized polyrotaxane may be an epoxidized polyrotaxane, explained in greater detail below.

Polyrotaxanes (PRs) are a specialized class of supramolecular structures composed of one or more ring-like molecules (cyclic components) that are non-covalently threaded over a linear polymer chain with bulky end groups capping each chain termini to prevent dethreading of the ring molecules. Polyrotaxanes are linked by mechanical bonding, such as hydrogen bonding or charge transfer, not covalent bonds as is the case with conventional polymers. Also, the rings are capable of rotating on or shuttling around the axles, resulting in the larger amount of molecular freedom of polyrotaxanes. This unconventional combination of molecules leads to the distinctive properties of polyrotaxanes.

The chain polymer is not particularly limited, as long as it is a chain polymer passing through the cyclic molecules in a skewering manner. The chain polymer may be linear or branched. The chain polymer may be selected from the group consisting of polyvinyl alcohol, polyvinylpyrrolidone, celluloses (such as carboxymethylcellulose, hydroxyethylcellulose, hydroxypropylcellulose and the like), polyacrylamide, polyethylene oxide, polyethylene glycol, polypropylene glycol, copolymers of propylene oxide and ethylene oxide, polyvinyl acetal, polyvinyl methyl ether, polyamine, polyethyleneimine, casein, gelatin, starch, polyolefins (such as polyethylene, polypropylene, and copolymer resins with other olefinic monomers), polyesters (such as polycaprolactone), polyvinyl chloride resins, polystyrenes (such as polystyrene, acrylonitrile-styrene copolymer resin and the like), acrylates (such as polymethyl methacrylate, copolymers of (meth)acrylate, acrylonitrile-methyl acrylate copolymer and the like), polycarbonates, polyurethanes, vinyl chloride-vinyl acetate copolymer, polyvinylbutyral and the like; polyisobutylene, polytetrahydrofuran, polyaniline, acrylonitrile-butadiene-styrene copolymer (ABS resin), polyamides, polyimides, polydienes (such as polyisoprene, polybutadiene and the like), polysiloxanes (such as polydimethylsiloxane and the like), polysulfones, polyimines, polycarboxylic acid anhydrides, polyureas, polysulfides, polyphosphazenes, polyketones, polyphenylenes, polyhaloolefins, and derivatives thereof. In particular embodiments, polyester, polyethylene glycol, or polypropylene glycol form the chain polymer.

The chain polymer of the polyrotaxane has at its ends capping groups, i.e., the groups that prevent the cyclic molecules from disengaging from the chain polymer. Thus, both ends of the chain polymer are too large to pass through the cyclic molecules, and the cyclic molecules are held over the chain polymer in such a state that the chain polymer passes through the cyclic molecules in a skewing manner.

The capping group is not particularly limited, as long as it is placed at the ends of the chain polymer and can prevent the disengagement of the cyclic molecules from the chain polymer. For example, the capping group may be selected from the group consisting of adamantane groups, dinitrophenyl groups (such as 2,4-dinitrophenyl and 3,5-dinitrophenyl), dialkylphenyls, cyclodextrins, trityl groups, fluoresceins, pyrenes, substituted benzenes (such as alkyl benzene, alkyloxy benzene, phenol, halobenzene, cyanobenzene, benzoic acid, amino benzene and the like), polycyclic aromatics which may be substituted, steroids, and derivatives thereof. In one or more embodiments, the capping group may be selected from the group consisting of adamantane groups, dinitrophenyl groups, cyclodextrins, trityl groups, fluoresceins, and pyrenes; more preferably, adamantane groups.

The weight average molecular amount of the chain polymer (a part of the chain polymer in the polyrotaxane) is not particularly limited and, for example, may be 1,000 to 500,000 Da. In some embodiments, the weight average molecular amount of the chain polymer (a part of the chain polymer in the polyrotaxane) is 20,000 Da or less. The weight average molecular amount of the chain polymer may be measured with gel permeation chromatography (GPC) chain polymer, for example, based on the standard curve created from the elution time, and the molecular weight using a chain polymer with a known molecular weight as a standard reagent.

The cyclic component may include (but is not limited to) cyclodextrin, crown ether, pillararene, calixarene, cyclophane, cucurbituril, and derivatives thereof. In particular embodiments, the cyclic component is cyclodextrin, and it is sparsely incorporated in the backbone linear chain. The atomic coverage of the cyclic component on the main chain polymer is not limited and, for example, may be from about 1 to 50 atomic %. The atomic coverage of the cyclic component on the main chain polymer may be estimated from NMR data. Cyclodextrin may be subsequently crosslinked or form secondary bonding with different polyrotaxanes or the rigid polymer to exert enhanced molecular mobility for improvement of ductility and toughenability of the polymer matrix without necessarily causing adverse effects (such as lowering of Tg and modulus).

In one or more embodiments, the cyclic component may be represented by formula (III):

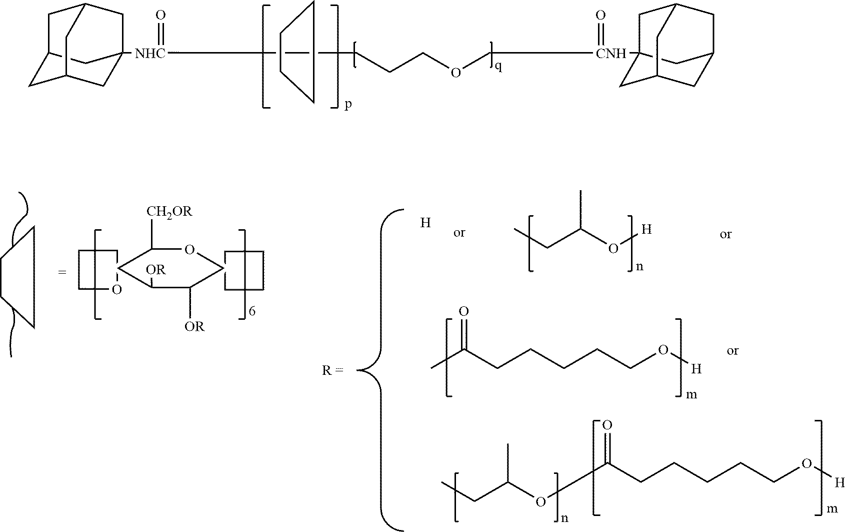

When R is hydrogen, the structure is referred to herein as “polyrotaxane” or PR. When R is a non-hydrogen functionality, the structure is referred to herein as “functionalized polyrotaxane.” n can be either 1 or 2 and m is in the range between 11-13.

In one or more embodiments, the polyrotaxanes may be represented by formula (IV):

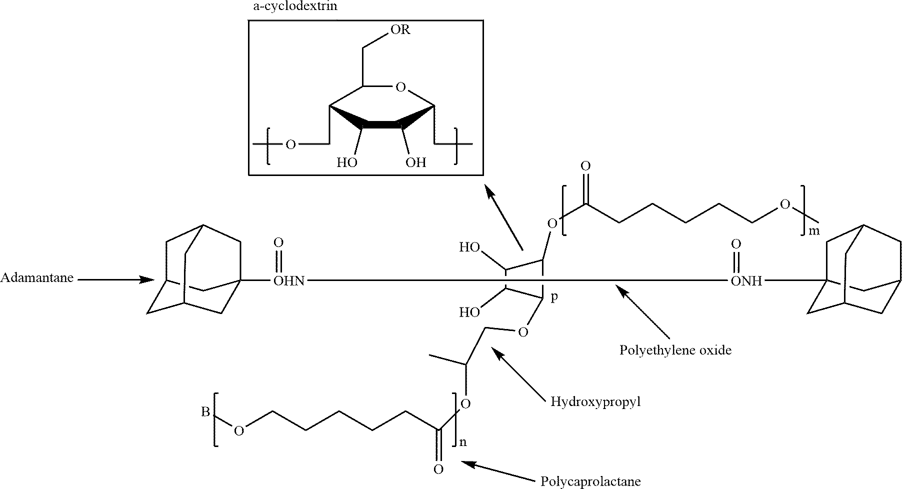

Where m and n are in the range between 11 to 13, p is 35, and R is H or selected from the following groups represented by the formula (V), (VI), and (VII):

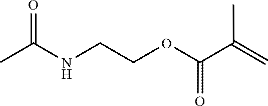

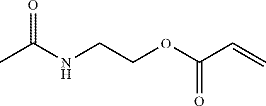

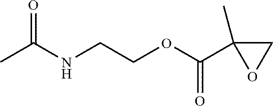

Polyrotaxane may be prepared using a wide variety of the chain polymers and the cyclic molecules as described above. Capping chemistry is used to prevent the chain polymers from disentangling with the cyclic molecules. Polyrotaxanes may be modified to enhance the miscibility and reactivity of the polyrotaxane with the rigid polymer. At least a part of the hydroxyl groups of the plurality of the cyclic molecules may be substituted with a reactive group, to enhance the reactivity of the polyrotaxane with the rigid polymer. The modification of the hydroxyl groups may either be complete or partial, and it may be achieved by esterification and/or etherification. This modification may be useful to tailor the interaction of the polyrotaxane with the polymer. Examples of suitable reactive groups include (but are not limited to) an olefin group, a hydroxy group, a carboxylic group, an amino group, an epoxy group, an acrylate group, an isocyanate group, a thiol group, and an aldehyde group.

In particular embodiments, polyrotaxanes of the present disclosure may be commercially available products or may be synthesized. Commercially available polyrotaxanes may include SeRM Super Polymer SH, SM and SA series from ASM Inc. The SM series from ASM Inc. (such as SM1303P) are polyrotaxane derivatives having radical crosslinkable functional groups like methacrylates. Polyrotaxanes having methacrylate functionality are herein after referred to as “MPR” and are considered to have reactive properties as described above. Epoxidized polyrotaxane, herein after referred to as “EPR”, may be synthesized from MPR, and is considered to be reactive with the rigid polymer (as previously described).

EPR may be synthesized via a solution synthesis method in one or more embodiments. In an exemplary embodiment, EPR may be synthesized by first dissolving MPR (as previously described) in methyl ethyl ketone and dichloromethane. Then, meta-chloroperoxybenzoic acid dissolved in dichloromethane may be slowly added to the MPR mixture. After stirring for about two days at room temperature, EPR product may be formed. The product may be appropriately washed using NaHCO₃ and water. Excess dichloromethane may be removed by dissolution in acetone followed by evaporation of the dichloromethane in acetone.

In one or more embodiments, the benzoxazine resin may be included in the thermosetting resin composition in an amount ranging between about 90% to about 99.5% by weight, based on the combined weight of the benzoxazine resin, the polyrotaxane and the optional core-shell polymer. The benzoxazine may be included in the thermosetting resin composition in an amount ranging from a lower limit of any of 89.5 wt%, 90 wt%, 92 wt%, 93 wt%, 94 wt%, or 95 wt% and an upper limit of any of 95.5 96 wt%, 97 wt%, 98 wt%, 98.5 wt%, 99 wt%, or 99.5 wt%, based on the combined weight of the benzoxazine resin, the polyrotaxane and the optional core-shell polymer , where any lower limit may be used in combination with any upper limit. In embodiments where higher crosslinking density and higher mechanical strength are desired in the cured article, the benzoxazine may be included in the thermosetting composition in an amount ranging between about 93 wt% and to about 98 wt%, based on the combined weight of the benzoxazine resin, the polyrotaxane and the optional core-shell polymer . In embodiments using rigid polymers other than a benzoxazine resin, the amount of rigid polymer present in the resin composition may similarly range from 90 to 99.5 wt%, based on the combined weight of the rigid polymer, the polyrotaxane and the optional core-shell polymer. The amount of the benzoxazine resin present, relative to the total weight of the thermosetting resin composition, may be up to 99.5% by weight, but may be lower than 90 wt% when other components, discussed below, are present.

In one or more embodiments, the polyrotaxane may be included in the resin composition in an amount ranging between about 1.0% to about 5.0% by weight, based on the combined weight of the benzoxazine resin, the polyrotaxane and the optional core-shell polymer . The polyrotaxane may be included in the resin composition in an amount having a lower limit of any of 0.5 wt.%, 1.0 wt%, 1.5 wt%, 2.0%, 2.5 wt% or 3.0 wt%, to an upper limit of any of 3.0 wt%, 3.5 wt%, 4.0 wt%, 4.5 wt% or 5.0 wt%, based on the combined weight of the benzoxazine resin, the polyrotaxane, and the optional core-shell polymer , where any lower limit can be used in combination with any upper limit. The amount of the polyrotaxane present, relative to the total weight of the thermosetting resin composition, may be up to 5% by weight, but may be lower than 0.5 wt% when other components, discussed below, are present.

In one or more embodiments, the resin composition may optionally include a core-shell polymer particle as an additional toughener. In particular embodiments, the core-shell polymer particle may be a core-shell rubber (CSR). Core-shell polymer particles in accordance with the present disclosure generally have at least two components, a core of the particle and a shell surrounding the core. The core is generally a rubber polymer having glass transition temperature (Tg) of less than 0° C. In one or more embodiments, the core-shell polymer of the present disclosure may be a core-shell polymer obtained by graft-polymerizing a monomer to form the shell in the presence of a rubber polymer, which serves as the core. Thus, the resultant structure of the core-shell polymer includes a rubber polymer core surrounded by a graft-polymerized shell. In one or more embodiments, the core-shell polymer may be grafted by glycidyl methacrylate. In particular embodiments, the core-shell polymer may be a commercially available product such as Kane Ace® MX-257 and Kane Ace® MX-150 (commercially available from Kaneka Corp.). In one or more embodiments, the core-shell rubber may be functionalized to improve properties such as miscibility with the rigid polymer and mechanical properties. In particular embodiments, the core-shell polymer may be dispersed in benzoxazine monomer (referred to herein as “BCSR”).

The weight ratio of the core to the shell of the core-shell polymers of the present disclosure may be in a range of about 50:50 to 99: 1, or 60:40 to 95:5, or 70:30 to 95:5 (as a weight ratio of monomers for forming each polymer). The core-shell polymers of the present disclosure may have a volume average particle diameter of from about 0.01 to 1 µm.

In one or more embodiments, the core-shell polymer may be included in the resin composition in an amount ranging between about 1.0% to about 10.0% by weight, based on the combined weight of the benzoxazine resin, the polyrotaxane, and the core-shell polymer. The core-shell polymer may be included in the resin composition in an amount having a lower limit of any of 1.0 wt%, 1.5 wt%, 2.0 wt%, 2.5 wt% 3.0 wt%, 3.5 wt%, 4.0 wt%, 4.5 wt%, or 5 wt% to an upper limit of any of 5.5 wt%, 6.0 wt%, 6.5 wt%, 7.0 wt%, 7.5 wt%, 8.0 wt%, 8.5 wt%, 9.0 wt%, 9.5 wt%, or 10.0 wt%, based on the combined weight of the benzoxazine resin, the polyrotaxane, and the core-shell polymer, where any lower limit can be used in combination with any upper limit.

It is also envisioned that in addition to the rigid polymer (such as but not limited to the benzoxazine resin), polyrotaxane, and core-shell polymer, the resin composition may also include solvents, fillers, and other non-reactive components. For example, a resin composition may include up to 50 wt% solvent when forming laminates, for example, and it is understood that such solvent may be removed during preparation of a prepreg.

The resin composition of the present disclosure may be synthesized via any suitable polymer synthesis method. For example, the thermosetting resin composition may be made via solution or melt polymerization methods. It may be advantageous to use solution polymerization methods with certain rigid polymer compositions to ensure adequate dispersion and mixing of the components of the rigid polymer composition. However, melt polymerization is also generally suitable.

In particular embodiments, each resin component (e.g., the benzoxazine-based resin, the core-shell polymer particles, and the polyrotaxane polymer) may be separately dissolved in a solvent. The solvent may be chosen based on the compatibility of the resin component being solvated. Then, the solvated resin components may be blended and the solvent removed, such as via evaporation at elevated temperature. Once the solvent is removed, the viscous uncured polymer resin may be transferred to an appropriate mold for curing.

In one or more embodiments, upon curing, a thermosetting resin composition comprising the benzoxazine-based resin, core-shell polymer particles, and polyrotaxane may crosslink, providing thermoset properties. The BZ resin undergoes a ring-opening and rearrangement to form a phenolic structure with a high degree of crosslinking. The epoxide group in EPR may react with the phenolic groups in the benzoxazine-based resin. Similarly, benzoxazine functionality on the CSR may also react with the benzoxazine-based resin and/or the polyrotaxane.

In one or more embodiments, the thermosetting resin composition may be cured by thermal activation at a temperature range of 100 to 200° C. The thermosetting resin composition may be subjected to a longer period of curing time at the lower end of the range and a shorter period of time at the upper end of the range based on the desired application.

In one or more embodiments, the thermosetting resin composition may be thermally cured for a time of a range of 30 minutes to 6 hours. In embodiments in which multiple curing steps are employed, the resin may be cured at a first temperature, then the temperature may be increased for a second curing step at a higher temperature. In such embodiments, the first temperature may be in a range of about 100 to 150° C. and the second temperature may be in a range of about 150 to 200° C. In particular embodiments, the thermosetting resin composition may be cured at about 120° C. for 2 hours, with the temperature ramped up to about 180° C. over the course of one hour and cured at 180° C. for 3 hours.

In one or more embodiments, the thermosetting resin composition may have an onset curing temperature below 220° C., below 210° C., or below 200° C.

As noted previously, when used in combination, tougheners such as polyrotaxanes and CSR, improve the toughness and ductility without a significant reduction in the Tg of the cured thermoset, as is the case with many tougheners. Advantageously, upon curing, the glass transition temperature of the disclosed thermoset may be comparable to the glass transition temperature of a rigid polymer having polyrotaxanes and CSR, such as a polybenzoxazine. In one or more particular embodiments, the cured thermoset has a glass transition temperature (Tg) within 5° C. of a cured rigid polymer having polyrotaxanes and CSR. The glass transition temperature may be within 5° C., 7° C., 10° C., 12° C., or 15° C. of a cured rigid polymer having polyrotaxanes and CSR.

In one or more embodiments, the cured thermoset composition may have Tg in a range of from about 150° C. to about 200° C. The cured thermoset may have a Tg having a lower limit of any of 150° C., 160° C., or 170° C., to an upper limit of any of 180° C., 190° C., or 200° C., where any lower limit can be used in combination with any upper limit.

In one or more embodiments, the cured thermoset may have a tensile strength, measured according to ASTM D638-98, ranging from about 50 to about 120 MPa. The cured thermoset may have a tensile strength having a lower limit of any of 50 MPa, 60 MPa, 70 MPa, or 80 MPa, to an upper limit of any of 90 MPa, 100 MPa, 110 MPa, or 120 MPa, where any lower limit can be used in combination with any upper limit.

The cured thermoset may have a tensile strength that is greater than a reference cured thermoset having only the rigid polymer, such as a benzoxazine cured thermoset, when measured according to ASTM D638-98. The tensile strength of the cured thermoset may be 2% greater, 4% greater, 6% greater, 8% greater, 10% greater, 12% greater, 15% greater, 20% greater, or 25% greater than a reference cured thermoset having only the rigid polymer, when measured according to ASTM D638-98.

As noted previously, when used in combination, tougheners such as polyrotaxanes and CSR generally provide a greater tensile modulus of the thermoset as compared to rigid polymers having conventional tougheners such as CSR alone. In one or more embodiments, the cured thermoset may have a tensile modulus, measured according to ASTM D638-98, that is greater than a reference cured thermoset with the rigid polymer resin and a conventional toughener such as a methacrylate functionalized core shell polymer. When using a reference for comparison, the amount of the conventional toughener in the reference should be the same as the amount of toughener (i.e., functionalized polyrotaxane and (optionally) CSR) in the inventive composition. In one or more embodiments, the cured thermoset may have a tensile modulus of at least 3% greater, at least 5% greater, at least 7% greater, at least 10% greater, at least 12% greater, at least 15% greater, or at least 20% greater than a reference cured thermoset with the rigid polymer resin and a methacrylate functionalized core shell polymer, when measured according to ASTM D638-98.

The cured thermoset may have a greater elongation at break than a reference rigid polymer that does not include polyrotaxane or core-shell polymer particles. In one or more embodiments, the cured thermoset may have an elongation at break of at least 5% greater, at least 7% greater, at least 10% greater, at least 12% greater, at least 15% greater, at least 20% greater, at least 25% greater, at least 30% greater, at least 35% greater, at least 40% greater, or at least 50% greater than a reference cured thermoset of a rigid polymer resin alone when measured according to ASTM D638-98. In one or more embodiments, the rigid polymer may have an elongation at break measured according to ASTM D638-98, ranging from about 1.0 to about 10.0%. The cured thermoset may have an elongation at break having a lower limit of any of 1.0 %, 1.2 %, 1.4 %, 1.6 %, 1.8 %, 2.0 %, 2.2 %, 2.4 %, or 2.6 %, to an upper limit of any of 2.8 %, 3.0 %, 3.2 %, 3.4 %, 3.6 %, 3.8 %, 4.0 %, 4.2 %, 4.4 %, 4.6 %, 4.8 %, or 5.0 %, where any lower limit can be used in combination with any upper limit.

The cured thermoset may have a greater mode-I critical-stress-intensity factor (K_{IC}), indicative of toughness, than a reference rigid polymer that does not include polyrotaxane or core-shell polymer particles. In one or more embodiments, the cured thermoset may have a mode-I critical-stress-intensity factor (K_{IC}) measured according to ASTM D5045-14, of at least 10% greater, at least 12% greater, at least 15% greater, at least 17% greater, at least 20% greater, at least 25% greater, at least 30% greater, at least 35% greater, at least 40% greater, at least 45% greater, at least 50% greater, at least 75% greater, or at least 100% greater than a reference cured thermoset of the rigid polymer resin alone, when measured according to ASTM D5045-14.

The rigid polymer may have a greater mode-I critical-stress-intensity factor (G_{IC}), indicative of toughness, than a reference rigid polymer that does not include polyrotaxane or core-shell polymer particles. In one or more embodiments, the cured thermoset resin may have a mode-I critical-strain energy release rate (G_{IC}), measured according to ASTM D5045-14, of at least 30% greater, at least 35% greater, at least 40% greater, at least 45% greater, or at least 50% greater than a reference cured thermoset of the rigid polymer resin alone.

Thermosetting resin compositions in accordance with the present disclosure may be used to form articles for a variety of applications. In one or more particular embodiments, the thermosetting resin composition of the present disclosure may be used to form prepregs, composite materials, adhesives, coatings, etc. Specifically, the thermosetting resin composition as discussed above may be combined with reinforcement fibers to form a composite material or structure, including prepregs formed by impregnating a layer or weave of fibers. Prepregs may be prepared by dissolving resin components in a solvent to form a “dope”. Reinforcing fabric, typically woven glass or carbon fiber, may then be passed through a bath containing the dope. The solvent is then removed from the fiber and the resin may be partially cured in a continuous process using a heated, ventilated oven called a treater. In some embodiments, a resin film may be formed from the thermosetting resin composition by, for example, compression molding, extrusion, melt-casting, or belt-casting, followed by laminating such film to one or both opposing surfaces of another layer -- including for example a layer of reinforcement fibers in the form of, for example, a non-woven mat of relatively short fibers, a woven fabric of continuous fibers, or a layer of unilaterally aligned fibers (i.e., fibers aligned along the same direction) -- at temperature and pressure sufficient to cause the resin film to flow and impregnate the fibers. Alternatively, a prepreg may be fabricated by providing the hybrid resin composition in liquid form, passing the layer of fibers through the liquid resin composition to infuse the layer of fibers with the heat curable composition, and removing the excess resin from the infused fibrous layer.

To fabricate a composite part from prepregs, plies of impregnated reinforcing fibers are laid up on a tool and laminated together by heat and pressure, for example by autoclave, vacuum, or compression molding, or by heated rollers, at the curing temperature range of the resin composition and at a pressure in particular in excess of 1 bar, preferably in the range of 1 to 10 bar.

Thus, in accordance with embodiments of the present disclosure, the thermosetting resin may be melt-processed to apply the thermosetting resin, such as to form a pre-preg, composite, coating, adhesive layer, etc. During or following such application, once the thermosetting resin is desired to set, the thermosetting resin may be cured to trigger ring-opening or crosslinking within the benzoxazine resin, thereby triggering thermosetting properties. Copper foil may be layered on one or both sides to form laminates useful for printed circuit boards. In this process the resin may be fully cured and the prepreg layers (and optionally copper foil) are joined by the cured resin, forming a laminate.

In the formation of a coating or adhesive layer, application of the formulated coating can be made via conventional methods such as spraying, roller coating, dip coating, etc., and then the coated system may be cured by baking.

### Examples

The following examples are merely illustrative and should not be interpreted as limiting the scope of the present disclosure.

### Materials

PR SH 1300 (M_{w} = 180,000 g/mol) and MPR methacrylate polyrotaxanes SM1303P (M_{w} = 180,000 g/mol) were obtained from ASM Inc. Acetone, propylene glycol methyl ether (PM), and methyl ethyl ketone (MEK) were obtained from ASM Inc.

### Methods

Proton nuclear magnetic resonance spectroscopy (400 MHz) spectra were acquired in chloroform-D. Chemical shifts were referenced to solvent resonance signals.

Differential scanning calorimetry (DSC) measurements were carried out using a Q20 DSC model from TA Instruments at a heating rate of 10° C./min in a N₂ atmosphere.

Dynamic mechanical analysis (DMA) measurements were conducted using an ARES-G2 model from TA instruments at a heating rate of 3° C./min in the range of 120 to 250° C. and a fixed frequency of 1 Hz. A sinusoidal strain amplitude of 0.05% was used for the analysis. Dimensions of the rectangular samples were 30 x 10 x 3.5 mm³. Tg was measured from an onset of a storage modulus curve (intersection of two tangent lines before and after an inflection point).

Tensile data were measured as per ASTM D638-98 using an MTS servohydraulic test machine at a crosshead speed of 5.08 mm/min. Strain data were collected using a calibrated MTS extensometer model 632.11B-20.

Fracture toughness tests were conducted based on linear elastic fracture mechanics approach. The dimensions of single-edge-notch bending (SENB) specimens were 6.4 mm (width) x 35.0 mm (length) x 3.2 mm (thickness). Data were measured as per ASTM D5045-14 on an Instron 5567 with a 30 kN load cell at a loading rate of 0.508 mm/min. Notches were introduced by a notching machine in the middle area of each sample. Pre-cracks were located at the bottom of notches and generated from tapping with razor blades chilled by liquid nitrogen.

The mode-I critical-stress-intensity factor (K_{IC}) was calculated and defined as in Equation 1:

$${K}_{I C} = \frac{{P}_{Q}}{\sqrt[B]{W}} f \left(x\right)$$

where P_{Q} is peak load, B is specimen thickness, W is specimen width, and f(x) is the geometric factor, in turn calculated and defined as Equation 2:

$$f \left(x\right) = \frac{\left(2 + x\right) \left(0.886 + 4.64 x - 13.22 {x}^{2} + 14.72 {x}^{3} - 5.6 {x}^{4}\right)}{{\left(1 - x\right)}^{3 / 2}}$$

where x=a/W and a is initial crack length. Data were measured as per ASTM D5045-14 using Instron 5567 with a 30 kN load cell (MTS) at a loading rate of 0.508 mm/min. The mode-I critical strain energy release rate, G_{IC}, was calculated and defined as in Equation 3:

$${G}_{I C} = \frac{{K}_{I C} {}^{2}}{E} \left(1 - {v}^{2}\right)$$

where E is tensile modulus and v is Poisson’s ratio, which is assumed to be 0.36 and 0.38 for neat and core-shell polymer-toughened epoxy, respectively.

The scratch test was conducted based on the ASTM D7027/ISO19252 test methodology. A linearly increasing normal load of 1-250 N was applied. The scratch speed and length were 10 mm/s and 80 mm, respectively. A 1 mm diameter spherical stainless-steel tip was used. The onset of visibility was identified by a Tribometrics® software package (Surface Machine Systems) based on the 3 % contrast and 90 % continuity settings. The onset of cracking and plowing formation and their corresponding damage features were identified using a laser scanning confocal microscope. The onset loads for the damage transitions were obtained from the scratch test data by identifying the normal load corresponding to the onset of scratch damage transitions. The scratch coefficient of friction study was obtained by taking the ratio of the tangential load and the normal load during the scratch test. In-situ scratch depth was measured by the instrumented scratch machine by tracking the scratch path height location of the spherical tip during the test. The original surface height profile was determined by applying a constant load of 1 N on the scratch tip across the 80 mm scratch path. Then, the in-situ scratch depth was calculated by subtracting the scratch path height profile during the actual scratch test from the original surface height profile before scratching. Residual scratch depth was measured by a laser scanning confocal microscope on the scratch path height profile after 48 hours.

### Preparation of Benzoxazine Acetone Solutions

100 g of benzoxazine monomer was dissolved in 100 g of acetone and stirred overnight at room temperature. The benzoxazine acetone solution was purified by using a 450 nm pore size PTFE syringe filter.

### Preparation of Epoxide Modified Polyrotaxanes (EPR)

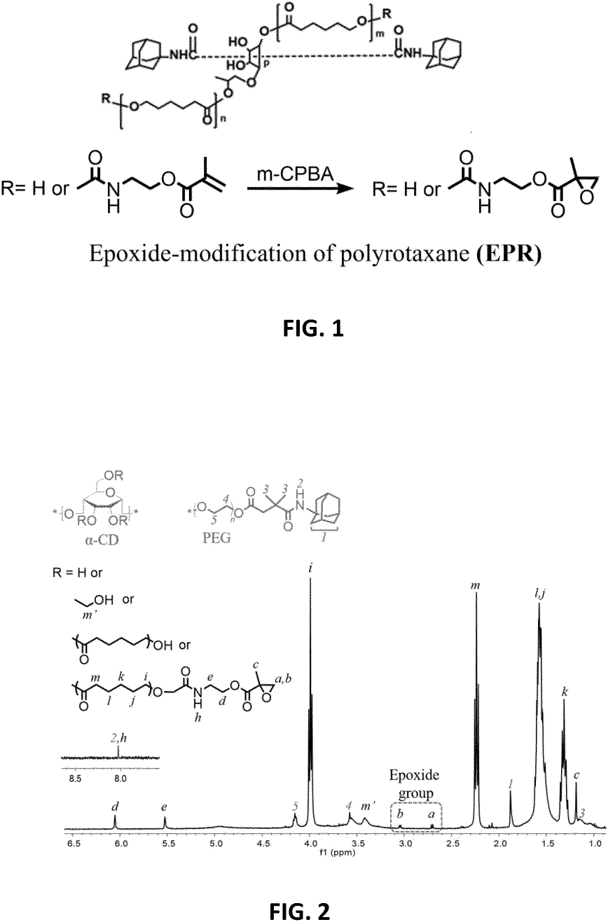

A general illustration of the reaction scheme of making an epoxide modified polyrotaxane is provided by FIG. 1. In accordance with the scheme shown in FIGS. 1, 1.0 g of MPR in 1.0 g of methyl ethyl ketone (MEK) was added to a glass bottle and dissolved in 15.0 mL of dicloromethane (DCM). 0.7 g of meta-chloroperoxybenzoic acid (m-CPBA) was dissolved in 5.0 mL of DCM and slowly added to the MPR/ MEK solution. The glass bottle was covered by aluminum foil and stirred for 2 days at room temperature. After completion, the reaction was washed by saturated solution of NaHCO₃ (1.0 g of NaHCO₃ dissolved in 12.5 mL of DI-water). The solution was further washed by 50 mL of DI-water 3 times. The DCM was removed by using a rotary evaporator at 50° C. The reaction mixture was suspended in 20.0 mL of acetone. FIG. 2 shows the NMR spectrum obtained from analyzing the final product. The NMR confirms the presence of the functional groups of an epoxide modified polyrotaxane.

### Preparation of Core-Shell Polymer Particles Solution (MCSR Solution)

Core-shell polymer particles were dispersed in propylene glycol methyl ether (PM) and MEK at a concentration of 25 wt% where styrene-butadiene rubber (SBR) and acrylic copolymer were used as core and shell of the particles, respectively. The diameter of core-shell particles was about 100 nm.

### Preparation of Core-Shell Polymer Masterbatch (BCSR Masterbatch)

The core-shell polymer particles with SBR and acrylic copolymer were dispersed in benzoxazine monomer at a concentration of 25 wt%.

### Thermosetting Resin Compositions

14 different thermosetting resin compositions with polybenzoxazine and additives were prepared. The composition of the resins is listed in Table 1.

TABLE 1

Composition of Thermosetting Resins.

| Sample | Benzoxazine (g) | PR (g) | EPR(g) | MPR (g) | MCSR solution (g) | BCSR masterbatch (g) |
|---|---|---|---|---|---|---|
| 1 | 20.0 | 0 | 0 | 0 | 0 | 0 |
| 2 | 19.6 | 0.4 | 0 | 0 | 0 | 0 |
| 3 | 19.2 | 0.8 | 0 | 0 | 0 | 0 |
| 4 | 19.6 | 0 | 0.4 | 0 | 0 | 0 |
| 5 | 19.2 | 0 | 0.8 | 0 | 0 | 0 |
| 6 | 19.6 | 0 | 0 | 0.4 | 0 | 0 |
| 7 | 19.4 | 0 | 0 | 0 | 2.4 | 0 |
| 8 | 19.0 | 0.4 | 0 | 0 | 2.4 | 0 |
| 9 | 19.0 | 0 | 0 | 0.4 | 2.4 | 0 |
| 10 | 19.0 | 0 | 0.4 | 0 | 2.4 | 0 |
| 11 | 17.6 | 0 | 0 | 0 | 0 | 2.4 |
| 12 | 17.2 | 0.4 | 0 | 0 | 0 | 2.4 |
| 13 | 17.2 | 0 | 0.4 | 0 | 0 | 2.4 |
| 14 | 16.8 | 0 | 0.8 | 0 | 0 | 2.4 |

### Sample 1: Polybenzoxazine (PBZ)

Benzoxazine (20 g) acetone solution (prepared in Example 1) was placed in a glass vial. The acetone solvent was removed by rotary evaporation at 50° C. for 30 minutes. An increase in the viscosity of the mixture was observed. The viscous mixture was poured into a preheated glass mold that was pretreated with PTFE mold release agent. The size of the glass plaque was 200 mm (8″) x 200 mm (8″) x 3.12 mm (0.125″). The resin was degassed in a vacuum oven at 80° C. for 2 hours. The resin was cured at 120° C. for 2 hours, ramped up to 180° C. over 1 hour, and cured at 180° C. for 3 hours in an oven.

### Sample 2: PBZ/ PR (2 wt%)

PR (0.4 g) was dissolved in acetone (10 g). Benzoxazine (19.6 g) acetone solution (prepared in Example 1) was placed in a glass vial. PR acetone solution was added to the glass vial with benzoxazine acetone. The mixture was sonicated for 10 minutes. The acetone solvent was removed by rotary evaporation at 50° C. for 30 minutes. An increase in the viscosity of the mixture was observed. The viscous mixture was poured into a preheated glass mold that was pretreated with PTFE mold release agent. The resin was degassed in a vacuum oven at 80° C. for 2 hours. The resin was cured at 120° C. for 2 hours, ramped up to 180° C. over 1 hour, and cured at 180° C. for 3 hours in an oven.

### Sample 3: PBZ/ PR (4 wt%)

PR (0.8 g) was dissolved in acetone (10 g). Benzoxazine (19.2 g) acetone solution (prepared in Example 1) was placed in a glass vial. PR acetone solution was added to the glass vial with benzoxazine acetone. The mixture was sonicated for 10 minutes. The acetone solvent was removed by rotary evaporation at 50° C. for 30 minutes. An increase in the viscosity of the mixture was observed. The viscous mixture was poured into a preheated glass mold that was pretreated with PTFE mold release agent. The resin was degassed in a vacuum oven at 80° C. for 2 hours. The resin was cured at 120° C. for 2 hours, ramped up to 180° C. over 1 hour, and cured at 180° C. for 3 hours in an oven.

### Sample 4: PBZ/EPR (2 wt%)

Benzoxazine (19.6 g) acetone solution (prepared in Example 1) and EPR (0.4 g) acetone solution were placed in a glass vial. The mixture was sonicated for 10 minutes. The acetone solvent was removed by rotary evaporation at 50° C. for 30 minutes. An increase in the viscosity of the mixture was observed. The viscous mixture was poured into a preheated glass mold that was pretreated with PTFE mold release agent. The resin was degassed in a vacuum oven at 80° C. for 2 hours. The resin was cured at 120° C. for 2 hours, ramped up to 180° C. over 1 hour, and cured at 180° C. for 3 hours in an oven.

### Sample 5: PBZ/EPR (4 wt%)

Benzoxazine (19.2 g) acetone solution (prepared in Example 1) and EPR (0.8 g) acetone solution were placed in a glass vial. The mixture was sonicated for 10 minutes. The acetone solvent was removed by rotary evaporation at 50° C. for 30 minutes. An increase in the viscosity of the mixture was observed. The viscous mixture was poured into a preheated glass mold that was pretreated with PTFE mold release agent. The resin was degassed in a vacuum oven at 80° C. for 2 hours. The resin was cured at 120° C. for 2 hours, ramped up to 180° C. over 1 hour, and cured at 180° C. for 3 hours in an oven.

### Sample 6: PBZ/MPR (2 wt%)

Benzoxazine (19.6 g) acetone solution (prepared in Example 1) and MPR (0.4 g) PM/MEK solution were placed in a glass vial. The mixture was sonicated for 10 minutes. The acetone solvent was removed by rotary evaporation at 50° C. for 30 minutes. An increase in the viscosity of the mixture was observed. The viscous mixture was poured into a preheated glass mold that was pretreated with PTFE mold release agent. The resin was degassed in a vacuum oven at 80° C. for 2 hours. The resin was cured at 120° C. for 2 hours, ramped up to 180° C. over 1 hour, and cured at 180° C. for 3 hours in an oven.

### Sample 7: PBZ/MCSR (3 wt%)

Benzoxazine (19.4 g) acetone solution (prepared in Example 1) and MCSR PM/MEK solution (2.4 g) were placed in a glass vial. The mixture was sonicated for 10 minutes. The acetone solvent was removed by rotary evaporation at 50° C. for 30 minutes. An increase in the viscosity of the mixture was observed. The viscous mixture was poured into a preheated glass mold that was pretreated with PTFE mold release agent. The resin was degassed in a vacuum oven at 80° C. for 2 hours. The resin was cured at 120° C. for 2 hours, ramped up to 180° C. over 1 hour, and cured at 180° C. for 3 hours in an oven.

### Sample 8: PBZ/MCSR (3 wt%)/ PR (2 wt%)

Benzoxazine (19 g) acetone solution (prepared in Example 1) MCSR PM/MEK solution (2.4 g), and PR (0.4 g) acetone solution were placed in a glass vial. The mixture was sonicated for 10 minutes. The acetone solvent was removed by rotary evaporation at 50° C. for 30 minutes. An increase in the viscosity of the mixture was observed. The viscous mixture was poured into a preheated glass mold that was pretreated with PTFE mold release agent. The resin was degassed in a vacuum oven at 80° C. for 2 hours. The resin was cured at 120° C. for 2 hours, ramped up to 180° C. over 1 hour, and cured at 180° C. for 3 hours in an oven.

### Sample 9: PBZ/MCSR (3 wt%)/ MPR (2 wt%)

Benzoxazine (19 g) acetone solution (prepared in Example 1) MCSR PM/MEK solution (2.4 g), and MPR (0.4 g) acetone solution were placed in a glass vial. The mixture was sonicated for 10 minutes. The acetone solvent was removed by rotary evaporation at 50° C. for 30 minutes. An increase in the viscosity of the mixture was observed. The viscous mixture was poured into a preheated glass mold that was pretreated with PTFE mold release agent. The resin was degassed in a vacuum oven at 80° C. for 2 hours. The resin was cured at 120° C. for 2 hours, ramped up to 180° C. over 1 hour, and cured at 180° C. for 3 hours in an oven.

### Sample 10: PBZ/ MCSR (3 wt%)/ EPR (2 wt%)

Benzoxazine (19 g) acetone solution (prepared in Example 1) MCSR PM/MEK solution (2.4 g), and EPR (0.4 g) acetone solution were placed in a glass vial. The mixture was sonicated for 10 minutes. The acetone solvent was removed by rotary evaporation at 50° C. for 30 minutes. An increase in the viscosity of the mixture was observed. The viscous mixture was poured into a preheated glass mold that was pretreated with PTFE mold release agent. The resin was degassed in a vacuum oven at 80° C. for 2 hours. The resin was cured at 120° C. for 2 hours, ramped up to 180° C. over 1 hour, and cured at 180° C. for 3 hours in an oven.

### Sample 11: PBZ/ BCSR (3 wt%)

Benzoxazine (17.6 g) acetone solution (prepared in Example 1) and BCSR masterbatch (2.4 g) were placed in a glass vial. The mixture was sonicated for 10 minutes. The acetone solvent was removed by rotary evaporation at 50° C. for 30 minutes. An increase in the viscosity of the mixture was observed. The viscous mixture was poured into a preheated glass mold that was pretreated with PTFE mold release agent. The resin was degassed in a vacuum oven at 80° C. for 2 hours. The resin was cured at 120° C. for 2 hours, ramped up to 180° C. over 1 hour, and cured at 180° C. for 3 hours in an oven.

### Sample 12: PBZ/ BCSR (3 wt%)/ PR (2 wt%)

Benzoxazine (17.2 g) acetone solution (prepared in Example 1) BCSR masterbatch (2.4 g), and PR (0.4 g) acetone solution were placed in a glass vial. The mixture was sonicated for 10 minutes. The acetone solvent was removed by rotary evaporation at 50° C. for 30 minutes. An increase in the viscosity of the mixture was observed. The viscous mixture was poured into a preheated glass mold that was pretreated with PTFE mold release agent. The resin was degassed in a vacuum oven at 80° C. for 2 hours. The resin was cured at 120° C. for 2 hours, ramped up to 180° C. over 1 hour, and cured at 180° C. for 3 hours in an oven.

### Sample 13: PBZ/ BCSR (3 wt%)/ EPR (2 wt%)

Benzoxazine (17.2 g) acetone solution (prepared in Example 1) BCSR masterbatch (2.4 g), and EPR (0.4 g) acetone solution were placed in a glass vial. The mixture was sonicated for 10 minutes. The acetone solvent was removed by rotary evaporation at 50° C. for 30 minutes. An increase in the viscosity of the mixture was observed. The viscous mixture was poured into a preheated glass mold that was pretreated with PTFE mold release agent. The resin was degassed in a vacuum oven at 80° C. for 2 hours. The resin was cured at 120° C. for 2 hours, ramped up to 180° C. over 1 hour, and cured at 180° C. for 3 hours in an oven.

### Sample 14: PBZ/ BCSR (3 wt%)/ EPR (4 wt%)

Benzoxazine (16.8 g) acetone solution (prepared in Example 1) BCSR masterbatch (2.4 g), and EPR (0.8 g) acetone solution were placed in a glass vial. The mixture was sonicated for 10 minutes. The acetone solvent was removed by rotary evaporation at 50° C. for 30 minutes. An increase in the viscosity of the mixture was observed. The viscous mixture was poured into a preheated glass mold that was pretreated with PTFE mold release agent. The resin was degassed in a vacuum oven at 80° C. for 2 hours. The resin was cured at 120° C. for 2 hours, ramped up to 180 °Cover 1 hour, and cured at 180° C. for 3 hours in an oven.

Table 2 includes composition of cured thermosets. CE-A to CE-D are examples from the prior art.

TABLE 2

Compositions of prior art resins

| Sample | Composition |
|---|---|
| CE-A | PBZ/ 10 wt% silica |
| CE-B | PBZ/ 10 wt% ABA* |
| CE-C | PBZ/ 20 wt% polyurethane |
| CE-D | PBZ/ 5 wt% CSR |
| Sample 12 | BZ/ 3 wt% CSR/ 2 wt% EPR |

*ABA = PBMA-PBA-PBMA where A is poly(benzylmethacrylate) (PBMA) and B is poly(butylacrylate)(PBA)

The mechanical properties of the samples with one additive in Table 1 are provided in Table 3.

TABLE 3

Mechanical Properties of PBZ and PBZ cured thermoset with one additive.

| Sample | Tg (°C) (by DMA) | Tensile strength (MPa) | Elongation at break (%) | Tensile modulus (GPa) | K_{IC} (MPa*m⁰.⁵) | G_{IC} (J/m²) |
|---|---|---|---|---|---|---|
| 1 (CE) | 164 | 45 ± 9 | 1.2 ± 0.2 | 4.54 ± 0.05 | 0.82 ± 0.07 | 140 ± 20 |
| 2 | 164 | 55 ± 3 | 1.6 ± 0.2 | 4.04 ± 0.08 | 1.01 ± 0.05 | 230 ± 20 |
| 3 | 163 | 74 ± 5 | 2.2 ± 0.1 | 3.98 ± 0.05 | 1.09 ± 0.04 | 270 ± 20 |
| 4 | 164 | 57 ± 6 | 1.6 ± 0.1 | 4.36 ± 0.04 | 0.95 ± 0.05 | 180 ± 30 |
| 5 | 163 | 70 ± 4 | 2.1 ± 0.2 | 4.30 ± 0.07 | 1.06 ± 0.03 | 240 ± 20 |
| 6 | 164 | 54 ± 2 | 1.5 ± 0.1 | 4.02 ± 0.02 | 1.05 ± 0.07 | 250 ± 30 |
| 7 | 165 | 90 ±7 | 2.5 ±0.2 | 4.19 ±0.11 | 1.22 ±0.04 | 330 ±20 |
| 11 | 174 | 93 ±3 | 2.7 ±0.1 | 4.25 ±0.03 | 1.23 ±0.03 | 330 ±20 |
| CE-A [PBZ] | 149 [159] | 135 [110] | 0 | 5.2 [5.2] | 0 | 175 [130] |
| CE-B [PBZ] | 181 [186] | 100 [100] | 0 | 4.2 [4.2] | 1.12 [0.76] | 245 [120] |
| CE-C [PBZ] | 193 [200] | 130 [170] | 0 | 4.0 [4.7] | 1.22 [0.78] | 327 [115] |
| CE-D [PBZ] | 178 [187] | 100 [100] | 0 | 4.1 [4.2] | 1.02 [0.85] | 0 |

As shown by the comparative examples from the prior art (i.e., samples CE-A through CE-D) in Table 3, additives like silica, PBMA/PBA/PBMA, polyurethane, and CSR provide an improvement in toughness (measured by K_{IC} and G_{IC}) but also result in a decrease in Tg and tensile modulus compared to PBZ only (i.e., sample 1). Additionally, in the comparative examples from the prior art (i.e., samples CE-A through CE-D), additives are used at high weight percent range from 5 to 20 wt%. In comparison, cured resin compositions 1-7 and 11 use only 2-4 wt% of one additive and still provide improved mechanical properties.

As shown by Samples 1-7 and 11 listed in Table 3, additives like core-shell polymer particles, modified core-shell polymers, polyrotaxanes, and modified polyrotaxanes lead to a notable improvement in mechanical properties, such as elongation at break, toughness, and tensile strength.

### PBZ, PBZ/PR, PBZ/MPR, and PBZ/ EPR Cured Thermosets

Samples 2 and 3 illustrate that an increase in wt% of PR in the cured thermoset from 2 wt% to 4 wt% improves the toughness (K_{IC}) from 0.82 to 1.09 MPa*m^{0.5}, but also decreases the Young’s modulus from 4.54 to 3.98 GPa compared to PBZ only thermoset (Sample 1). Samples 4 and 5 illustrate that an increase in wt% of EPR in the cured thermoset from 2 wt% to 4 wt% improves the toughness 0.82 to 1.06 MPa*m^{0.5}, with a slight decrease in Young’s modulus from 4.54 to 4.30 GPa compared to PBZ only thermoset (Sample 1). Such improvement in mechanical properties may be a result of additional complex chain movement caused by the introduction of EPR.

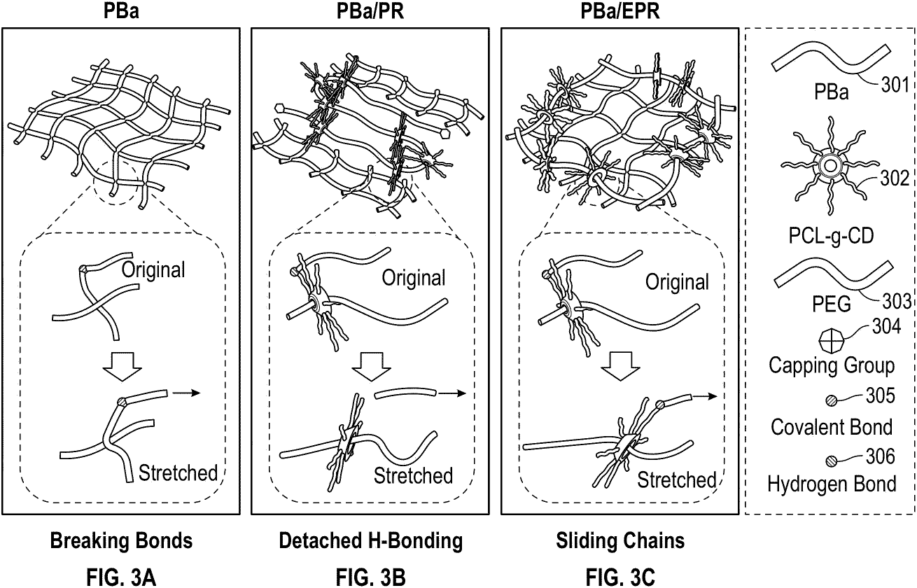

Without wishing to be bound by a particular mechanism or theory, it is believed that a possible mechanism for this improvement is the additional complex chain movement caused by the introduction of EPR. The hydrogen bonding of polybenzoxazine is manipulated by the addition of EPR. FIGS. 3A-3C shows a schematic of the possible molecular mechanism for improved ductility and toughening. FIG. 3A shows the molecular network of PBZ-cured thermoset. PBZ chains 301 are shown connected in a simplified schematic in FIG. 3A. FIG. 3B shows that the addition of PR 302, 303, 304 in the cured thermoset, resulting in hydrogen bonding 306 between the PR 302 and PBZ 301. The hydrogen bonding 306 may result in the improvement in toughness of Samples 2 and 3 compared to PBZ only thermoset. FIG. 3C shows the presence of a covalent bond 305 between the EPR 302 and PBZ 301. The covalent bond 305 may result in the improvement of both toughness and ductility of Samples 4 and 5 compared to PBZ 301 only thermoset (Sample 1).

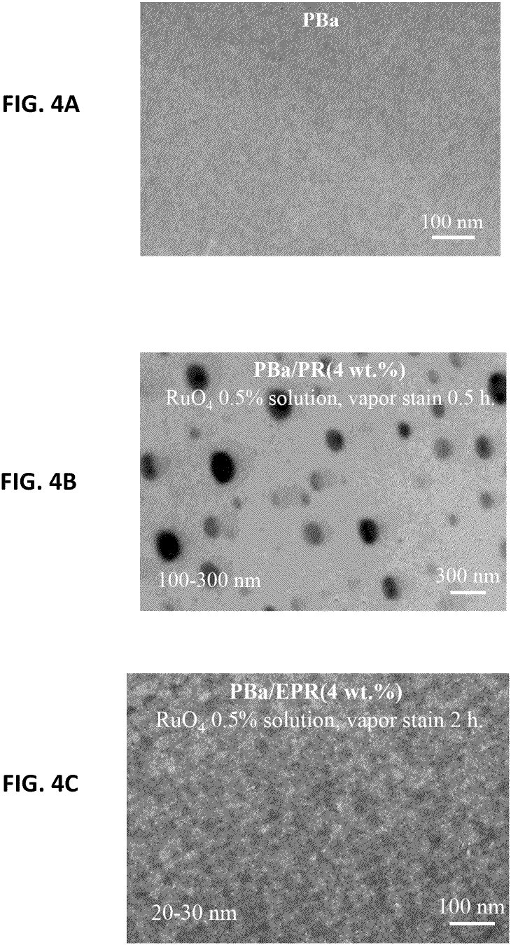

This mechanism is further supported by the TEM images shown in FIGS. 4A-4C. FIG. 4A is a TEM image of PBZ cured thermoset only. FIG. 4A shows a homogeneous sample of PBZ polymer alone. FIG. 4B is a TEM image of PBZ with 4 wt% PR cured thermoset. The dark spots in the TEM image indicate that PR is not well integrated in the PBZ matrix. A heterogeneous mixture of two phases is formed. On the other hand, FIG. 4C shows that EPR integrates well with the PBZ matrix, as evidenced by the homogeneous image with no dark spots (dark spots are indicative of heterogeneity). It is believed that this complete and homogeneous mixing of the PBZ and EPR compounds may also contribute to the improved properties of the aforementioned samples, including EPR.

Samples 2, 4, and 6 show the difference between EPR, PR, and MPR additives included in PBZ cured thermosets. When PR is included as an additive in PBZ, it provides an improvement in the strength of the thermoset but sacrifices modulus. EPR, in contrast, provides an improvement in mechanical properties and maintains a much higher Young’s modulus compared to PBZ with a PR additive. Thus, by utilizing the epoxide functionality, the toughness of the PBZ can be improved with less detriment to the modulus. Interestingly, an MPR additive results in a decrease in all mechanical properties when compared to a PR additive. Thus, simply functionalizing the PBZ does not necessarily result in improved properties. The functionality should be reactive with the BZ, as described previously.

The presence of an EPR additive increases the K_{IC} by at least 10%, tensile strength by at least 4%, and elongation at break by at least 5% compared to PBZ only cured thermoset.

### PBZ, PBZ/MCSR, and PBZ/BCSR Cured Thermosets

Samples 7 and 11 illustrate a combination of core-shell rubber (MCSR) and functionalized core-shell rubber (BCSR) improves the toughness (K_{IC}) from 0.82 to 1.23 MPa*m^{0.5}, but also decreases the Young’s modulus from 4.54 to 4.25 GPa compared to PBZ only thermoset (Sample 1). Samples 7 and 11 also increase the glass transition compared to PBZ only. It is believed that core-shell polymer particles improve toughness due to cavitation. In particular, during the deformation and fracture of a core-shell polymer toughened rigid polymer under a plane strain condition, the core-shell polymer may cavitate because of the low modulus and lower cohesive strength against cavitation, followed by plastic deformation of the cured thermoset. This cavitation may provide additional toughness under strain.

### PBZ with Multiple Additives Cured Thermoset

The mechanical properties of the samples with multiple additives in Table 1 are provided in Table 4.

TABLE 4

Mechanical Properties of PBZ and PBZ cured thermoset with multiple additives.

| Sample | Tg (°C) (by DMA) | Tensile strength (MPa) | Elongation at break (%) | Tensile modulus (GPa) | K_{IC} (MPa*m^{0.5}) | G_{IC} (J/m²) |
|---|---|---|---|---|---|---|
| 7 (CE) | 165 | 90 ±7 | 2.5 ±0.2 | 4.19 ±0.11 | 1.22 ±0.04 | 330 ±20 |
| 8 | 165 | 100 ±12 | 2.9 ±0.1 | 4.43 ±0.06 | 1.53 ±0.06 | 470 ±20 |
| 9 | 164 | 104 ±2 | 3.5 ±0.1 | 4.12 ±0.05 | 1.55 ±0.03 | 530 ±30 |
| 10 | 163 | 100 ±6 | 2.8 ±0.2 | 4.66 ±0.03 | 1.49 ±0.03 | 440 ±30 |
| 11 (CE) | 174 | 93 ±3 | 2.7 ±0.1 | 4.25 ±0.03 | 1.23 ±0.03 | 330 ±20 |
| 12 | 173 | 107 ±2 | 3.5 ±0.3 | 4.05 ±0.03 | 1.39 ±0.07 | 440 ±40 |
| 13 | 171 | 107 ±4 | 3.0 ±0.1 | 4.68 ±0.01 | 1.35 ±0.02 | 360 ±10 |
| 14 | 172 | 111 ±3 | 3.3 ±0.2 | 4.56 ±0.03 | 1.44 ±0.05 | 410 ±30 |

Samples 8-10 are cured thermosets comprising PBZ, MCSR, and either PR, MPR, or EPR. All three cured thermosets have improved tensile strength, elongation at break, and toughness (measured by K_{IC} and G_{IC}) compared to PBZ/ MCSR (Sample 7) cured thermosets. Samples 9 and 10 have a higher Young’s modulus compared to a PBZ/ MCSR cured thermoset. The improved mechanical properties may be attributed to the chemical bonding of epoxidized PR in benzoxazines to adequately enhance molecular mobility of benzoxazines with improved ductility and toughenability. This effect is not exhibited with other polyrotaxanes such as PR or MPR.

Samples 12-14 are cured thermosets comprising PBZ, BCSR, and one or more of PR, MPR, and EPR. All three cured thermosets have improved tensile strength, elongation at break, toughness (measured by K_{IC} and G_{IC}) compared to PBZ/ BCSR (Sample 11) cured thermosets. Samples 13 and 14 have a higher Young’s modulus compared to a PBZ/ BCSR (Sample 11) cured thermoset. Unexpectedly, Sample 14 even has a higher Young’s modulus compared to PBZ only cured thermoset. The exceptional properties of Sample 14 may be due to the synergistic toughening effect of a PBZ/ BCSR/ EPR hybrid system.

The scratch tests were performed for Samples 1, 3 and 5. The onset load of scratch visibility and material removal for Sample 1 is 47.4 and 101.1 N, respectively. These values were increased to 55.3 and 120.0 N for Sample 3, and decreased to 30.4 and 77.3 N for Sample 5. EPR has strong interaction with PBZ and improves the dispersion of PR in PBZ which can enhance scratch resistance and reduce the scratch coefficient of friction. Compared to Samples 1 and 3, Sample 5 shows a delayed onset of scratch visibility and material removal as well as better viscoelastic recovery on the scratch depth due to the enhanced strength and network recoverability of PBZ/ EPR.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words ‘means for’ together with an associated function.

What is claimed:

1. A resin composition, comprising:
a rigid polymer resin; and
a functionalized polyrotaxane.

2. The resin composition of claim 1, wherein the rigid polymer resin is a benzoxazine-based resin.

3. The resin composition of claim 1, wherein the functionalized polyrotaxane includes a functional group selected from the group consisting of a hydroxy group, a carboxylic group, an amino group, an epoxy group, an isocyanate group, a thiol group, an aldehyde group, and combinations thereof.

4. The resin composition of claim 1, wherein the functionalized polyrotaxane is an epoxidized polyrotaxane.

5. The resin composition of claim 1, further comprising a core-shell polymer.

6. The resin composition of claim 5, wherein the core-shell polymer is a core-shell rubber.

7. The core-shell rubber of claim 6, wherein the core-shell rubber is dispersed in a benzoxazine monomer.

8. The resin composition of claim 5, wherein the rigid polymer resin is present in an amount ranging from 89.5 to 98.5 wt% of the combined weight of the rigid polymer resin, the functionalized polyrotaxane, and the core-shell polymer.

9. The resin composition of claim 5, wherein the functionalized polyrotaxane is present in an amount ranging from 0.5 to 5.0 wt% of the combined weight of the rigid polymer resin, the functionalized polyrotaxane, and the core-shell polymer.

10. The resin composition of claim 5, wherein the core-shell polymer is present in an amount ranging from 1.0 to 10.0 wt% of the combined weight of the rigid polymer resin, the functionalized polyrotaxane, and the core-shell polymer.

11. A cured thermoset of the resin composition of claim 1.

12. The cured thermoset of claim 11, wherein the cured thermoset has a mode-I critical-stress-intensity factor (K_{IC}) of at least 10% greater than a reference cured thermoset of the rigid polymer resin alone, when measured according to ASTM D5045-14.

13. The cured thermoset of claim 11, wherein the cured thermoset has a tensile strength of at least 4% greater than a reference cured thermoset of the rigid polymer resin alone, when measured according to ASTM D638-98.

14. The cured thermoset of claim 11, wherein the cured thermoset has an elongation at break of at least 5% greater than a reference cured thermoset of the rigid polymer resin alone, when measured according to ASTM D638-98.

15. The cured thermoset of claim 11, wherein the cured thermoset has a glass transition temperature (Tg) within 5° C. of a reference cured thermoset of the rigid polymer resin alone, when measured by differential scanning calorimetry.

16. The cured thermoset of claim 11, wherein the cured thermoset has a tensile modulus of at least 3% greater than a reference cured thermoset with the rigid polymer resin and a methacrylate functionalized core shell polymer, when measured according to ASTM D638-98.

17. A method of forming a cured article of a curable composition, comprising:
providing the curable composition of claim 1; and
curing the curable composition to form the cured article.

18. The method of claim 17, wherein curing comprises thermal activation.
